(19) United States
(12) Patent Application Publication
(10) Pub. No.: US 2022/0137430 A1
(43) Pub. Date: May 5, 2022

(54) Motorized Flip-Lens Glasses

(71) Applicants: Sada Ly, Montreal (CA); Mamadou Ly, Montreal (CA)

(72) Inventors: Sada Ly, Montreal (CA); Mamadou Ly, Montreal (CA)

(21) Appl. No.: 17/515,274

(22) Filed: Oct. 29, 2021

Related U.S. Application Data
(60) Provisional application No. 63/107,345, filed on Oct. 29, 2020.

(51) Int. Cl. G02C 5/22; G02C 7/02; G02C 11/00

(52) U.S. Cl. CPC G02C 5/22; G02C 11/10; G02C 7/02

(57) ABSTRACT

A motorized flip-lens glasses is an apparatus that automatically positions a lens in front of and out of the line of sight of a user. The apparatus includes an eyeglass frame. The eyeglass frame is mounted on the face of the user as the eyeglass frame includes the left frame assembly, a right frame assembly, and a bridge bar. The left frame assembly and the right frame assembly each includes a stationary rim, a motor casing, a temple casing, a rotation mechanism, a movable rim, and a movable lens. The bridge bar connects the left frame assembly with the right frame assembly. The stationary rim allows connects the motor casing with the bridge bar. The motor casing and the temple casing house the rotation mechanism. The rotation mechanism rotates the movable rim. The movable rim upholds and surrounds the movable lens. The movable lens adjusts the vision of the user.

The current application claims a priority to the U.S. Provisional Patent application Ser. No. 63/107,345 filed on Oct. 29, 2020.

### FIELD OF THE INVENTION

The present invention generally relates to eyewear. More specifically, the present invention is a motorized flip-lens glasses.

### BACKGROUND OF THE INVENTION

People who wear prescription glasses usually see poorly from far but can see very well up close so they can usually very clearly see an object within a meter or less of them. Prescription glasses generally correct a huge part of this problem by allowing them to see very well at more than a meter away. Nevertheless, the convexity of the glasses makes it difficult to see well at close range, thus making the writings and diagrams on a sheet of paper less than a meter from them relatively blurry. That is why a lot of people with nearsightedness tend to take off their glasses when looking at a piece of paper or anything less than a meter from them. Taking off our glasses constantly to see well up-close wastes time, makes our glasses dirty easily, and increases the risk of breaking them depending on the environment we are in. In construction for example, we must regularly remove our glasses in a dirty and dusty place to take precise measurements and then put our glasses back on to go and accomplish a task. Removing your glasses manually is very problematic since your hands are almost always dirty, not to mention the time it takes to gently remove these glasses, trying not to get them dirty.

In order to put on or take off a pair of glasses quickly and easily without having to hold them in our hands or put them down somewhere, there is a reading glasses device that has a magnet which makes it possible to connect and disconnect the center of the bridge of the glasses. These types of glasses also have a connection between the two temple tips like a rope which allows the glasses to remain on the user's neck once the two magnets that keep the bridge attached have been separated. The disadvantage of doing things this way is that you have to remove the glasses manually to be able to see as if you were not wearing them and you have to put them back manually if you want to see through the glasses again, not to mention the fact that this method is slower and less efficient than our method.

### BRIEF DESCRIPTION OF THE DRAWINGS

FIG. 1 is a perspective view of a preferred embodiment of the present invention.

FIG. 2 is an exploded view of the present invention.

FIG. 3 is a perspective view of the preferred embodiment of the present invention in an open configuration.

FIG. 4 is a perspective view of an alternate embodiment of the present invention with a stationary lens of a left frame assembly and a stationary lens of a right frame assembly in an open configuration.

FIG. 5 is a rear side view of the preferred embodiment of the present invention in the open configuration.

FIG. 6 is a cross-section view taken along line 6-6 in FIG. 5.

FIG. 7 is a perspective view of an eyeglass container of the present invention.

FIG. 8 is a perspective view of the eyeglass container of the present invention with an eyeglass frame positioned within the eyeglass container.

FIG. 9 is a schematic view of the electronic components of the present invention.

### DETAILED DESCRIPTIONS OF THE INVENTION

All illustrations of the drawings are for the purpose of describing selected versions of the present invention and are not intended to limit the scope of the present invention.

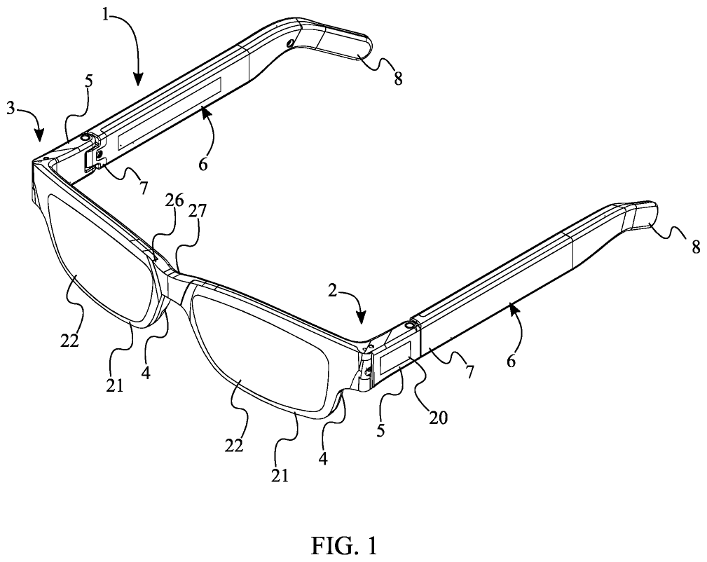

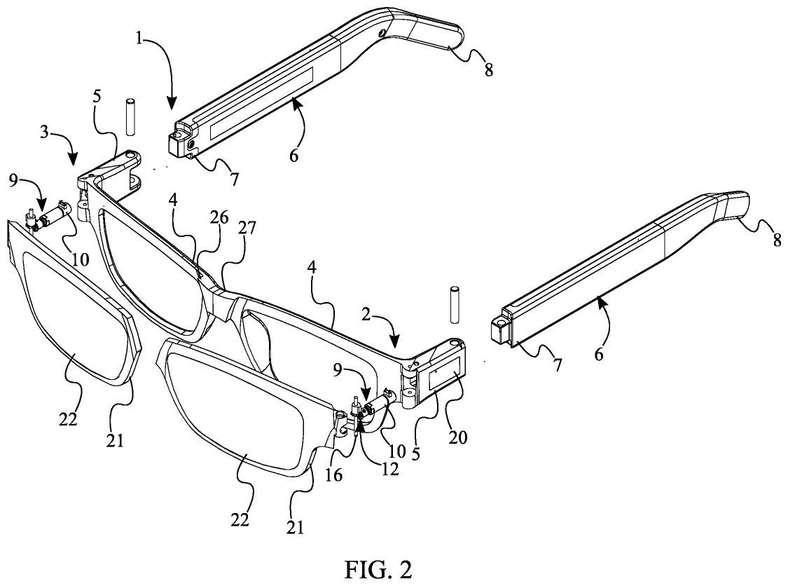

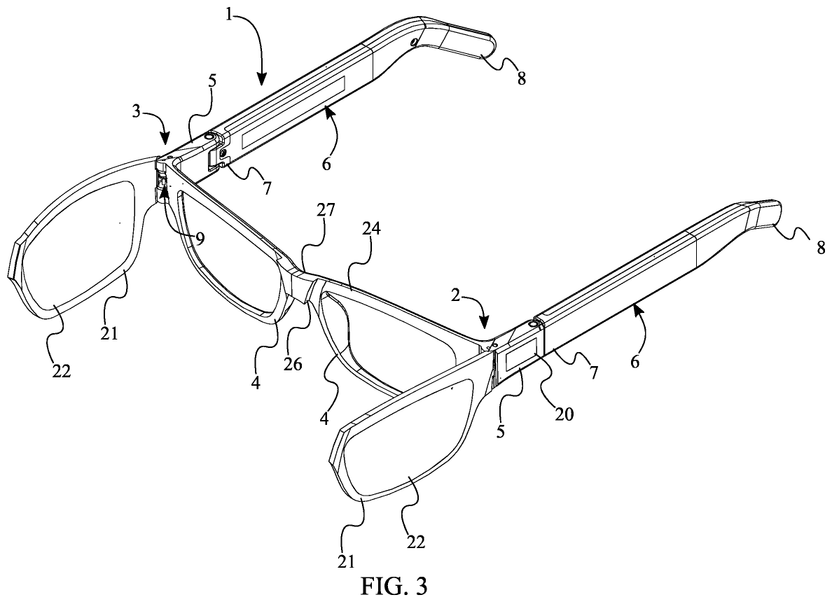

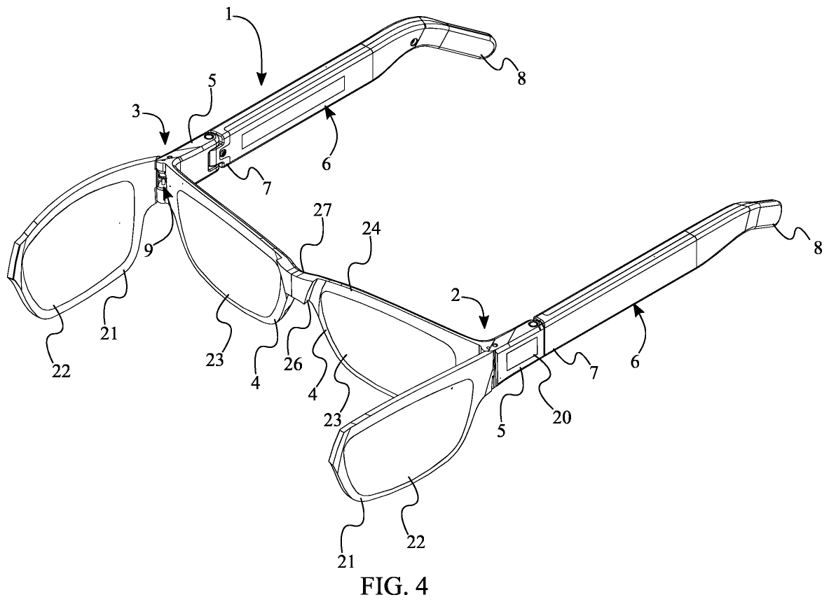

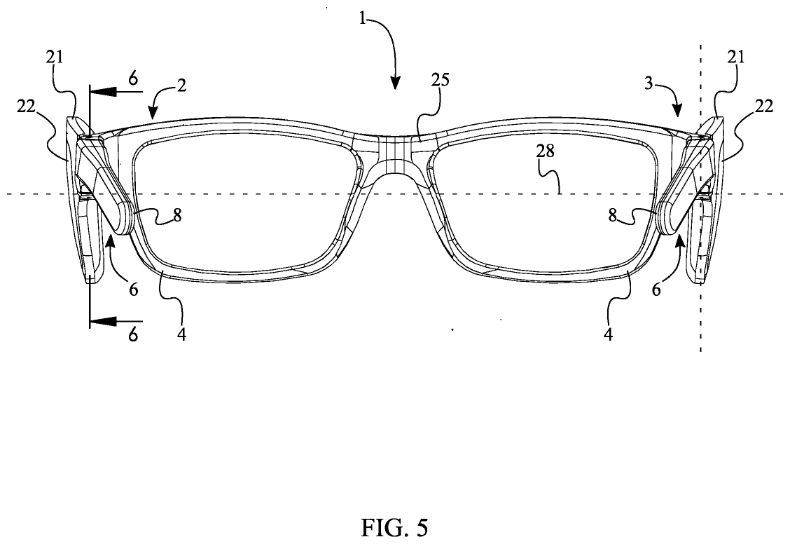

The present invention is a motorized flip-lens glasses. The present invention allows a user to automatically remove a pair of lenses from in front of the eyes without having to completely remove the present invention from the face of the user. The present invention, therefore, reduces the chances of losing the present invention as well as damaging the present invention. In order for the present invention to be utilized as eyewear, the present invention comprises an eyeglass frame 1. The eyeglasses frame upholds a pair of lenses in front of the eyes of the user. The eyeglass frame 1 is worn on the face of the user and is mountable on to the head of the user as the eyeglass frame 1 comprises a left frame assembly 2, a right frame assembly 3, and a bridge bar 27, seen in FIG. 1, FIG. 2, FIG. 3, FIG. 4, and FIG. 5. The left frame assembly 2 and the right frame assembly 3 uphold a pair of lenses in front of the eyes of the user and allows the eyeglass frame 1 to comfortably rest on the ears of the user. The bridge bar 27 connects the left frame assembly 2 and the right frame assembly 3 and allows the eyeglass frame 1 to comfortably rest on the nose of the user. The left frame assembly 2 and the right frame assembly 3 each comprise a stationary rim 4, a motor casing 5, a temple casing 6, a rotation mechanism 9, a movable rim 21, and a movable lens 22. The stationary rim 4 connects the motor casing 5 with the temple casing 6. The stationary rim 4 also allows the corresponding eye of the user to see through the movable lens 22. The motor casing 5 and the temple casing 6 house the rotation mechanism 9. Furthermore, the motor casing 5 allows the temple casing 6 to hinge with the stationary rim 4. The temple casing 6 rests extends the eyeglass frame 1 to the corresponding ear of the user and rests on the corresponding ear of the user. The rotation mechanism 9 allows the movable rim 21 to hinge with the stationary rim 4. The movable rim 21 upholds and connects the movable lens 22 with the stationary rim 4. The movable lens 22 alters vision of the user and may include but is not limited to, prescription lenses, magnifying lenses, protective lenses, and tinted lenses.

The overall configuration of the aforementioned components automatically positions the movable lens 22 in front of and out of the line of vision of a user while keeping the eyeglass frame 1 in front of the face of the user, seen in FIG. 1, FIG. 2, FIG. 3, FIG. 4, and FIG. 5. The bridge bar 27 is fixed in between the stationary rim 4 of the left frame portion and the stationary rim 4 of the right frame portion, thereby securely and comfortably bracing the face of the user. In order for the movable rim 21 to be rotated in front of and away from the stationary rim 4, the motor casing 5 is laterally mounted with the stationary rim 4, opposite the bridge bar 27. More specifically, the motor casing 5 is positioned perpendicular with the stationary rim 4 to preserve the overall structure of the eyeglass frame 1 as eyewear for the user. Furthermore, the temple casing 6 is positioned adjacent with the motor casing 5, opposite to the stationary rim 4. This arrangement allows the present invention to reach the ears of the user while positioning the movable rim 21 and the stationary in front of the eyes of the user. The motor casing 5 is hingedly connected with the temple casing 6 so that the temple casing 6 may rotate open and closed with the stationary rim 4. The user may view through the movable lens 22 and view without any aid as the movable rim 21 is hingedly connected to the stationary rim 4, opposite the motor casing 5. More specifically, the movable rim 21 is peripherally connected about the movable lens 22 such that the rotation mechanism 9 may rotate the movable lens 22 without ruining the integrity of the movable lens 22. The eyeglass frame 1 remains compact and has a minimalistic structure as the rotation mechanism 9 is mounted within the motor casing 5 and the temple casing 6. The movable rim 21, and consequently the movable lens 22 automatically moves into and out of the line of sight for the user as the rotation mechanism 9 is operatively coupled to the movable lens 22, wherein the rotation mechanism 9 is used to rotate the movable rim 21 coincident with the stationary rim 4 or is used to rotate the movable rim 21 offset from the stationary rim 4.

In the event double lenses are desired by a user, the left frame assembly 2 and the right frame assembly 3 may each further comprise a stationary lens 23, seen in FIG. 4. The stationary lens 23 is an additional lens that adjusts the vision of the user. The stationary lens 23 may be used independently and in tandem with the movable lens 22. In order to position the stationary lens 23 in the line of sight for the user, the stationary rim 4 is peripherally connected about the stationary lens 23. The eyesight of the user is therefore first adjusted with the stationary lens 23 and further adjusted with the movable lens 22 while used simultaneously. This arrangement may be preferred while needing, for example, a prescription lens along with a tinted lens or a prescription lens along with a protective lens.

In order to contour around the face of a user while in use and remain compact while not in use, the temple casing 6 may further comprise a fixed casing end 7 and a free casing end 8, seen in FIG. 1, FIG. 2, FIG. 3, FIG. 4, and FIG. 5. The fixed casing end 7 attaches the temple casing 6 with the motor casing 5. The free casing end 8 rest on or around the ear of the user. Moreover, the fixed casing end 7 is positioned opposite the free casing end 8 along the temple casing 6, thereby defining an overall length of the temple casing 6. In order to connect with the motor casing 5, the fixed casing end 7 is positioned adjacent with the motor casing 5, opposite the stationary rim 4. The temple casing 6 may open and be in line with the motor casing 5 while in use as well as close and be parallel with both the stationary rim 4 of the left frame assembly 2 and the stationary rim 4 of the right frame assembly 3 as the fixed casing is hingedly connected with the motor casing 5.

In order to secure the position of the movable rim 21 against the stationary rim 4 while in use, the eyeglass frame 1 may further comprise a rim-bracing protrusion 26, seen in FIG. 1, FIG. 2, FIG. 3, FIG. 4, and FIG. 5. The rim-bracing protrusion 26 maintains a smooth visible exterior while the movable rim 21 is pressed against the stationary rim 4 and reduces the chances of the movable rim 21 getting snagged as the rim-bracing protrusion 26 occupies the space between the movable rim 21 of the left frame assembly 2 and the movable rim 21 of the right frame assembly 3. Moreover, the stationary rim 4 may comprise a distal rim surface 24 and a proximal rim surface 25. The distal rim surface 24 is oriented towards the surrounding environment of the present invention while being worn by the user. The proximal rim surface 25 is oriented towards the face of the user. More specifically, the distal rim surface 24 is positioned opposite the proximal rim surface 25 about the stationary rim 4. As the distal rim surface 24 is oriented towards the surrounding environment of the user, the movable rim 21 is positioned adjacent with the distal rim surface 24 and is fixed onto the bridge bar 27, adjacent to the distal rim surface 24. The eyeglass frame 1 maintains a smooth and continuous surface from the movable rim 21 of the left bracing assembly to the movable rim 21 of the right bracing assembly as the rim-bracing protrusion 26 is positioned in between the movable rim 21 of the left frame assembly 2 and the movable rim 21 of the right frame assembly 3.

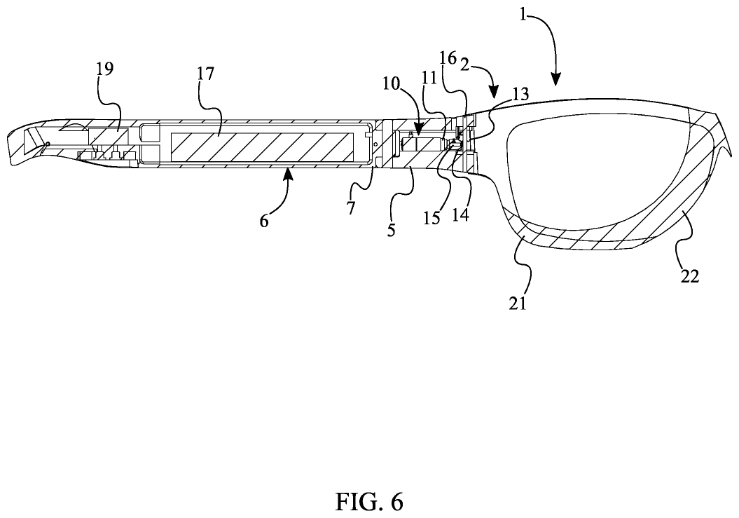

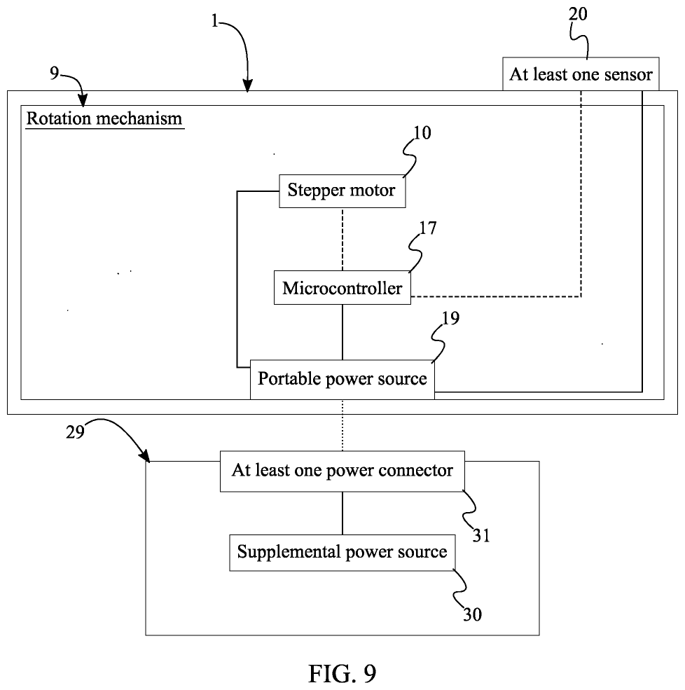

In order to flip open and flip closed the movable rim 21 with the stationary rim 4, the rotation mechanism 9 may comprise a stepper motor 10, a straight bevel gear train 12, an output shaft 16, a microcontroller 17, at least one sensor 20, and a portable power source 19, seen in FIG. 2, FIG. 6, and FIG. 9. The stepper motor 10 maneuvers the straight bevel gear. The straight bevel gear translates the rotation from the stepper motor 10 to the output shaft 16. The output shaft 16 rotates the movable rim 21. The microcontroller 17 operates and process commands for the stepper motor 10, the at least one sensor 20, and the portable power source 19. The at least one sensor 20 detects when the movable rim 21 should be rotated. The at least one sensor 20 may be programmed to receive a variety of inputs, such as a single tap or a double tap, in order to control or maneuver the moveable rim 21 as desired by the user. In order to open and close the movable rim 21 based on the tilt of the head of a user, the at least one sensor 20 is an accelerometer. In order to open and close the movable rim 21 based on the distance between the eyeglass frame 1 and a surface, the at least one sensor 20 is a proximity sensor. In order to open and close the movable rim 21 with a voice command of a user, the at least one sensor 20 is an auditory sensor and a transmitter. In order to open and close the movable rim 21 with a finger of a user the at least one sensor 20 is a touch sensor. The portable power source 19 provides the necessary power supply for the stepper motor 10 and the microcontroller 17. In order to uphold and position the stepper motor 10 and the straight bevel gear train 12 adjacent with the movable rim 21, the stepper motor 10 and the straight bevel gear train 12 are mounted within the motor casing 5. The output shaft 16 may connect and rotate the movable rim 21 as the output shaft 16 is rotatably mounted into the motor casing 5. The at least one sensor 20 is externally mounted into the eyeglass frame 1 to be able detect the surrounding environment and receive input from the surrounding environment. Similarly, in order to uphold and position the microcontroller 17 and the portable power source 19 adjacent with the stepper motor 10, the microcontroller 17 and the portable power source 19 are mounted within the temple casing 6. In order for the rotation of the stepper motor 10 to engage the output shaft 16, the stepper motor 10 is operatively coupled with the straight bevel gear train 12, wherein the stepper motor 10 is used to rotate the straight bevel gear train 12. Consequently, the straight bevel gear train 12 is operatively coupled to the output shaft 16, wherein the straight bevel gear train 12 is used to rotate the output shaft 16. This arrangement translates the rotation of the stepper motor 10 to the output shaft 16 while the stepper motor 10 remains positioned perpendicular with the output shaft 16 as the stationary rim 4 is positioned perpendicular with the motor casing 5. The output shaft 16 is torsionally connected to the movable rim 21, thereby flipping out and flipping on the movable rim 21 with the stationary rim 4. The microcontroller 17 is electronically connected to the stepper motor 10 and the at least one sensor 20 in order to both maneuver the movable rim 21 as well as turn on and turn off the present invention. The portable power source 19 is electrically connected to the stepper motor 10, the microcontroller 17, and the at least one sensor 20. In order for the movable rim 21 of the left frame casing to rotate simultaneously with the movable rim 21 of the right frame casing, the microcontroller 17 of the left frame assembly 2 is electronically connected with the microcontroller 17 of the right frame assembly 3.

In the preferred embodiment of the present invention, the straight bevel gear train 12 comprises a horizonal bevel gear 13, a vertical bevel gear 14, and an input shaft 15, seen in FIG. 6. The horizontal bevel gear 13 rotates the output shaft 16, and the vertical bevel gear 14 rotates the horizontal bevel gear 13. The input shaft 15 connects the vertical bevel gear 14 with the stepper motor 10. The rotation of the motor is outputted as a rotor 11 of the stepper motor 10 is torsionally connected to the input shaft 15. The stepper motor 10 is able to rotate the vertical bevel gear 14 as the input shaft 15 is torsionally connected to the vertical bevel gear 14. The vertical bevel gear 14 is engaged with the horizontal bevel gear 13 thereby changing the axis of rotation between the rotor 11 and the output shaft 16. The horizontal bevel gear 13 is torsionally connected to the output shaft 16, thereby continuously translating the rotation from the stepper motor 10 to the output shaft 16. Moreover, the output shaft 16 is positioned perpendicular with the input shaft 15 in order to conform to the arrangement between the stationary frame and the motor casing 5.

In the preferred embodiment of the present invention, the output shaft 16 is positioned perpendicular a sightline 28 of the eyeglasses frame so that the movable rim 21 may flip out to the side of the eyeglass frame 1 and along the side of the head of the user, seen in FIG. 3, FIG. 4, and FIG. 5. The sightline 28 of the user is the visual axis of the user between both eyes. In alternate embodiments of the present invention, the output shaft 16 is positioned parallel a sightline 28 of the eyeglasses frame so that the movable rim 21 flips above the eyeglass frame 1 and across the forehead of the user.

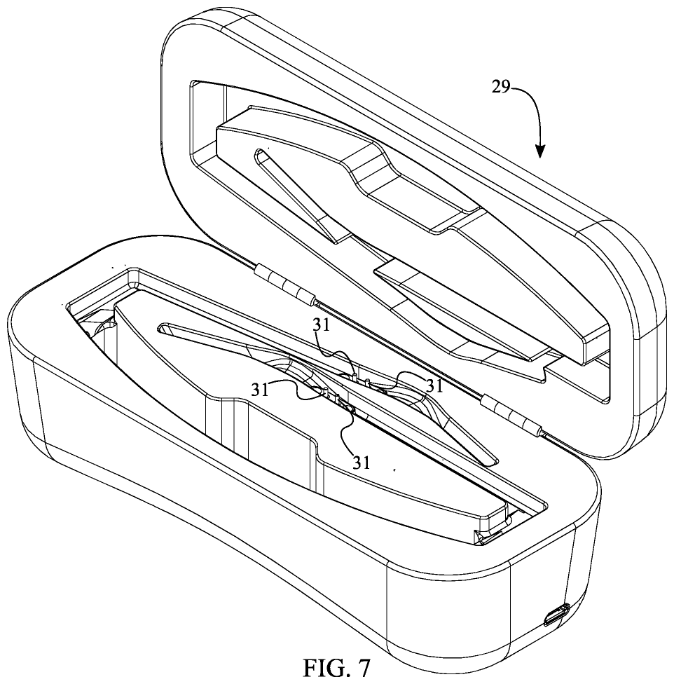

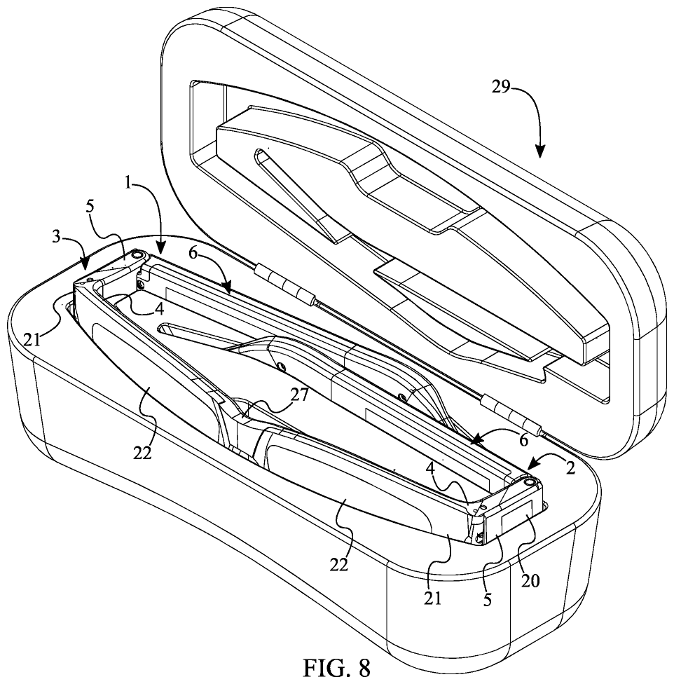

In order to recharge the present invention, the present invention may further comprise an eyeglass container 29, a supplemental power source 30, and at least one power connector 31, seen in FIG. 7, FIG. 8, and FIG. 9. The eyeglass container 29 houses and maintains a closed configuration for the eyeglass frame 1 while not in use. The eyeglass container 29 may comprise a base and a cover as well as a bed integrated into the base and the cover so that the eyeglass frame 1 remains fixed while within the eyeglass container 29. The closed configuration for the eyeglass frame 1 is such that the temple casing 6 is rotated inward and positioned adjacent with the stationary rim 4. The supplemental power source 30 is a more powerful portable battery that is able to supply the portable power source 19 with the necessary power. The supplemental power source 30 may also be rechargeable with a power cord and an external power source. The at least one power connector 31 physically connects with the portable power source 19 and delivers the power to the portable power source 19. The at least one power connector 31 is preferably a couple of prongs that are readily received by the portable power source 19 through an interface integrated into the temple casing 6. The portable power source 19 is recharged while not in use and housed within the eyeglass container 29 as the supplemental power source 30 is integrated into the eyeglass container 29, and the at least one power connector 31 is mounted within the eyeglass container 29. In order for the power to be transmittable through the at least one power connector 31, the supplemental power source 30 is electrically connected to the at least one power connector 31. As the portable power source 19 is housed within the temple casing 6, the eyeglass frame 1 is positioned within the eyeglass container 29. The at least one power connector 31 is electronically coupled to the portable power source 19 of the left frame assembly 2 and the portable power source 19 of the right frame assembly 3, thereby recharging the portable power source 19.

Although the invention has been explained in relation to its preferred embodiment, it is to be understood that many other possible modifications and variations can be made without departing from the spirit and scope of the invention as hereinafter claimed.

What is claimed is:

1. A motorized flip-lens glasses comprising:
an eyeglass frame;
the eyeglass frame comprising a left frame assembly, a right frame assembly, and a bridge bar;
the left frame assembly and the right frame assembly each comprising a stationary rim, a motor casing, a temple casing, a rotation mechanism, a movable rim, and a movable lens;
the bridge bar being fixed in between the stationary rim of the left frame portion and the stationary rim of the right frame portion;
the motor casing being laterally mounted with the stationary rim, opposite the bridge bar;
the motor casing being positioned perpendicular with the stationary rim;
the temple casing being positioned adjacent with the motor casing, opposite to the stationary rim;
the motor casing being hingedly connected with the temple casing;
the movable rim being hingedly connected to the stationary rim, opposite the motor casing;
the movable rim being peripherally connected about the movable lens;
the rotation mechanism being mounted within the motor casing and the temple casing; and,
the rotation mechanism being operatively coupled to the movable lens, wherein the rotation mechanism is used to rotate the movable rim coincident with the stationary rim or is used to rotate the movable rim offset from the stationary rim.

2. The motorized flip-lens glasses as claimed in claim 1 comprising:
the left frame assembly and the right frame assembly each further comprising a stationary lens; and,
the stationary rim being peripherally connected about the stationary lens.

3. The motorized flip-lens glasses as claimed in claim 1 comprising:
the temple casing comprising a fixed casing end and a free casing end;
the fixed casing end being positioned opposite the free casing end along the temple casing;
the fixed casing end being positioned adjacent with the motor casing, opposite the stationary rim; and,
the fixed casing end being hingedly connected with the motor casing.

4. The motorized flip-lens glasses as claimed in claim 1 comprising:
the eyeglass frame further comprising a rim-bracing protrusion;
the stationary rim comprising a distal rim surface and a proximal rim surface;
the distal rim surface being positioned opposite the proximal rim surface about the stationary rim;
the movable rim being positioned adjacent with the distal rim surface;
the rim-bracing protrusion being fixed onto with the bridge bar, adjacent to the distal rim surface; and,
the rim-bracing protrusion being positioned in between the movable rim of the left frame assembly and the movable rim of the right frame assembly.

5. The motorized flip-lens glasses as claimed in claim 1 comprising:
the rotation mechanism comprising a stepper motor, a straight bevel gear train, an output shaft, a microcontroller, at least one sensor, and a portable power source;
the stepper motor and the straight bevel gear train being mounted within the motor casing;
the output shaft being rotatably mounted into the motor casing;
the at least one sensor being externally mounted into the eyeglass frame;
the microcontroller and the portable power source being mounted within the temple casing;
the stepper motor being operatively coupled with the straight bevel gear train, wherein the stepper motor is used to rotate the straight bevel gear train;
the straight bevel gear train being operatively coupled to the output shaft, wherein the straight bevel gear train is used to rotate the output shaft;
the output shaft being torsionally connected to the movable rim;
the microcontroller being electronically connected to the stepper motor and at least one sensor;
the portable power source being electrically connected to the stepper motor, the microcontroller, and the at least one sensor; and,
the microcontroller of the left frame assembly being electronically connected with the microcontroller of the right frame assembly.

6. The motorized flip-lens glasses as claimed in claim 5 comprising:
the straight bevel gear train comprising a horizontal bevel gear, a vertical bevel gear, and an input shaft;
a rotor of the stepper motor being torsionally connected to the input shaft;
the input shaft being torsionally connected to the vertical bevel gear;
the vertical bevel gear being engaged with the horizontal bevel gear;
the horizontal bevel gear being torsionally connected to the output shaft; and,
the output shaft being positioned perpendicular with the input shaft.

7. The motorized flip-lens glasses as claimed in claim 5 comprising:
the output shaft being positioned perpendicular a sightline of the eyeglasses frame.

8. The motorized flip-lens glasses as claimed in claim 5 comprising:
the output shaft being positioned parallel a sightline of the eyeglasses frame.

9. The motorized flip-lens glasses as claimed in claim 5, wherein the at least one sensor is an accelerometer.

10. The motorized flip-lens glasses as claimed in claim 5, wherein the at least one sensor is a proximity sensor.

11. The motorized flip-lens glasses as claimed in claim 5, wherein the at least one sensor is an auditory sensor and a transmitter.

12. The motorized flip-lens glasses as claimed in claim 5, wherein the at least one sensor is a touch sensor.

13. The motorized flip-lens glasses as claimed in claim 5 comprising:
an eyeglass container;
a supplemental power source;
at least one power connector;
the supplemental power source being integrated into the eyeglass container;
the at least one power connector being mounted within the eyeglass container;
the supplemental power source being electrically connected to the at least one power connector;
the eyeglass frame being positioned within the eyeglass container; and,
the at least one power connector being electrically coupled to the portable power source of the left frame assembly and the portable power source of the right frame assembly.

14. A motorized flip-lens glasses comprising:
an eyeglass frame;
the eyeglass frame comprising a left frame assembly, a right frame assembly, and a bridge bar;
the left frame assembly and the right frame assembly each comprising a stationary rim, a motor casing, a temple casing, a rotation mechanism, a movable rim, a movable lens, and a stationary lens;
the rotation mechanism comprising a stepper motor, a straight bevel gear train, an output shaft, a microcontroller, at least one sensor, and a portable power source;
the bridge bar being fixed in between the stationary rim of the left frame portion and the stationary rim of the right frame portion;
the motor casing being laterally mounted with the stationary rim, opposite the bridge bar;
the motor casing being positioned perpendicular with the stationary rim;
the temple casing being positioned adjacent with the motor casing, opposite to the stationary rim;
the motor casing being hingedly connected with the temple casing;
the movable rim being hingedly connected to the stationary rim, opposite the motor casing;
the movable rim being peripherally connected about the movable lens;
the rotation mechanism being mounted within the motor casing and the temple casing;
the rotation mechanism being operatively coupled to the movable lens, wherein the rotation mechanism is used to rotate the movable rim coincident with the stationary rim or is used to rotate the movable rim offset from the stationary rim;
the stepper motor and the straight bevel gear train being mounted within the motor casing;
the output shaft being rotatably mounted into the motor casing;
the at least one sensor being externally mounted into the eyeglass frame;
the microcontroller and the portable power source being mounted within the temple casing;
the stepper motor being operatively coupled with the straight bevel gear train, wherein the stepper motor is used to rotate the straight bevel gear train;
the straight bevel gear train being operatively coupled to the output shaft, wherein the straight bevel gear train is used to rotate the output shaft;
the output shaft being torsionally connected to the movable rim;
the microcontroller being electronically connected to the stepper motor and at least one sensor;
the portable power source being electrically connected to the stepper motor, the microcontroller, and the at least one sensor;
the microcontroller of the left frame assembly being electronically connected with the microcontroller of the right frame assembly; and,
the stationary rim being peripherally connected about the stationary lens.

15. The motorized flip-lens glasses as claimed in claim 14 comprising:
the eyeglass frame further comprising a rim-bracing protrusion;
the temple casing comprising a fixed casing end and a free casing end;
the fixed casing end being positioned opposite the free casing end along the temple casing;
the fixed casing end being positioned adjacent with the motor casing, opposite the stationary rim;
the fixed casing end being hingedly connected with the motor casing;
the stationary rim comprising a distal rim surface and a proximal rim surface;
the distal rim surface being positioned opposite the proximal rim surface about the stationary rim;
the movable rim being positioned adjacent with the distal rim surface;
the rim-bracing protrusion being fixed onto with the bridge bar, adjacent to the distal rim surface; and,
the rim-bracing protrusion being positioned in between the movable rim of the left frame assembly and the movable rim of the right frame assembly.

16. The motorized flip-lens glasses as claimed in claim 14 comprising:
the straight bevel gear train comprising a horizontal bevel gear, a vertical bevel gear, and an input shaft;
a rotor of the stepper motor being torsionally connected to the input shaft;
the input shaft being torsionally connected to the vertical bevel gear;
the vertical bevel gear being engaged with the horizontal bevel gear;
the horizontal bevel gear being torsionally connected to the output shaft; and,
the output shaft being positioned perpendicular with the input shaft.

17. The motorized flip-lens glasses as claimed in claim 14 comprising:
the output shaft being positioned perpendicular a sightline of the eyeglasses frame.

18. The motorized flip-lens glasses as claimed in claim 14 comprising:
the output shaft being positioned parallel a sightline of the eyeglasses frame.

19. The motorized flip-lens glasses as claimed in claim 14, wherein the at least one sensor is selected from a group consisting of: an accelerometer; a proximity sensor; an auditory sensor and a transmitter; a touch sensor; and combinations thereof.

20. The motorized flip-lens glasses as claimed in claim 14 comprising:
an eyeglass container;
a supplemental power source;
at least one power connector;
the supplemental power source being integrated into the eyeglass container;
the at least one power connector being mounted within the eyeglass container;
the supplemental power source being electrically connected to the at least one power connector;
the eyeglass frame being positioned within the eyeglass container; and,
the at least one power connector being electrically coupled to the portable power source of the left frame assembly and the portable power source of the right frame assembly.
